(19) United States
(12) Patent Application Publication
(10) Pub. No.: US 2025/0390828 A1
(43) Pub. Date: Dec. 25, 2025

(54) AUTOMATED ADVISING MODEL HOSTING PLATFORM

(71) Applicant: Thor Strategic, LLC, Sanford, NC (US)

(72) Inventor: Zurich Awes, St. Croix (VI)

(21) Appl. No.: 19/246,442

(22) Filed: Jun. 23, 2025

Related U.S. Application Data
(60) Provisional application No. 63/662,882, filed on Jun. 21, 2024.

(51) Int. Cl. G06Q 10/0639; G06F 16/95

(52) U.S. Cl. CPC G06Q 10/06393; G06F 16/95

(57) ABSTRACT

In general, the present disclosure relates to a platform that hosts an automated advising model. The platform includes a number of potential data integrations, including integrations with third-party data sets, including public data sets. These integrations enable access to granular business information usable for organizational benchmarking. The integration of such third-party data sets enables the platform to elicit information from an organization that is highly relevant in nature, and provide automated feedback to the organization regarding operational changes that might be made to improve organizational health according to stated organization goals.

### CROSS-REFERENCE TO RELATED APPLICATIONS

The present application claims priority from U.S. Provisional Patent Application No. 63/662,882, filed on Jun. 21, 2024, the disclosure of which is hereby incorporated by reference in its entirety.

### BACKGROUND

It is common practice for large enterprises to engage consultants regarding the status or health of the enterprise, for example including financial health, operational health, risk exposure, and the like. These engagements often take significant time to complete and require significant expense on behalf of the enterprise seeking the consulting engagement. Nevertheless, enterprises often conduct such exercises, for example to improve cash flow, in advance of acquisition or being acquired, to improve valuation, and the like.

At smaller scale, for example privately owned or held businesses, it is often the case that these consulting services are unavailable. This is often because performing similar, extensive analysis of business operations is cost prohibitive. This is because of the highly custom analysis that is required, which results in significant hours of consulting time leading to high expense. Still further, consulting services often result in general observations regarding business trends, but lack actionable or quantifiable tasks to be performed by such businesses to improve operational health or valuation.

Existing solutions to this issue might involve an organization self-assessment platform in which an organization may enter what it believes to be salient details regarding business operations, with the platform providing generalized summaries and best practices for use within that organization. However, these solutions lack the detail and customization of the consulting work available to larger organizations. In particular, it is often the case that the summaries and best practices for use by smaller organizations may vary widely by business type, but the types of information that a smaller organization may be prompted to provide, and the manner in which advice is provided, are inadequately granular.

Overall, this results in solutions that are either significantly manual or too general purpose to be useful. For those manual systems, there is a practical limit to the timing and volume of advising that may be possible, as well as the ability of advisors to identify which possible enterprises could benefit from communications as the state of those enterprises changes.

Existing business valuation systems suffer from computational limitations when attempting to provide meaningful cross-organizational comparisons. Traditional approoaches using absolute values fail to account for scale differences between organizations, while manual valuation processes cannot efficiently process the volume of external data sources required for accurate sector-specific analysis.

### SUMMARY

In general, the present disclosure relates to a platform that hosts an automated advising model. The platform includes a number of potential data integrations, including integrations with third-party data sets, including public data sets. These integrations enable access to granular business information usable for organizational benchmarking. The integration of such third-party data sets enables the platform to elicit information from an organization that is highly relevant in nature, and provide automated feedback to the organization regarding operational changes that might be made to improve organizational health according to stated organization goals.

In accordance with the present disclosure, in a first aspect, a method of providing automated advising to an organization regarding business valuation includes presenting, at a web interface, a guided information collection interface, the guided information collection interface presenting a series of screens requesting information regarding organizational goals, operating sector information, and responsive information regarding a plurality of organizational components corresponding to at least one of financial, operational, and leadership performance. The method also includes receiving response inputs at the web interface from the organization, and based on the operating sector information, obtaining third party records providing historical third party financial data associated with the operating sector. The method further includes weighting a scoring model in accordance with features determined to be relevant to operational performance from the historical third party financial data, and generating a plurality of scores in response to the responsive information based on the scoring model. The method further includes, based on the plurality of scores, performing a valuation process at an organizational advising platform, the organizational advising platform determining an overall score from the plurality of scores and generating one or more valuations of the organization based on the overall score and the organizational goals. The one or more valuations are generated based on the responsive information and the plurality of scores.

In a second aspect, an automated advising model hosting platform includes a web interface configured to present a guided information collection interface to a client organization, the guided information collection interface presenting a series of screens requesting information regarding organizational goals, operating sector information, and responsive information regarding a plurality of organizational components corresponding to at least one of financial, operational, and leadership performance, the web interface being configured to receive response inputs at the web interface. The platform further includes a third party data interface configured to obtain operating sector information from a third party sector database and obtain third party records providing historical third party financial data associated with the operating sector, and a scoring model configured according to features extracted based on the historical third party financial data, the scoring model being operable to generate a plurality of scores in response to the responsive information. The automated advising model hosting platform is configured to perform a valuation process to determine an overall score from the plurality of scores and generate one or more valuations of the organization based on the overall score and the organizational goals. The one or more valuations are generated based on the responsive information and the plurality of scores.

In a third aspect, a method of providing comparative business analysis using delta-based calculations solves the fundamental technical challenge of enabling meaningful cross-organizational comparisons regardless of company size differences. The method receives organizational performance data over predetermined time periods and generates delta values by calculating percentage changes rather than using absolute metric values, enabling direct comparison between organizations with vastly different scales. A dynamic scoring algorithm assigns initial scores to delta values based on predetermined range thresholds and applies amplification factors based on score magnitude, with high-threshold scores receiving positive amplification and low-threshold scores receiving negative amplification. The method weights amplified scores using sector-specific weights determined from third-party comparative data associated with business classification codes and generates different weighted score combinations based on organizational goals, applying distinct weighting schemas for operational versus sale-oriented objectives. This delta-based approach enables automated, scalable comparative analysis while maintaining assessment accuracy through real-time external data integration.

In a fourth aspect, an automated business analysis system implements a sophisticated delta-based calculation architecture that transforms absolute organizational metrics into meaningful comparative assessments. The system includes a processor configured to execute instructions stored in memory and a delta-based calculation engine that receives organizational performance data from client interfaces and generates comparative delta values from the performance data. The calculation engine applies dynamic amplification factors to initial scores derived from delta values, weights the amplified scores using sector-specific weightings obtained from external databases, and generates multiple weighted assessments based on different organizational goal parameters.

### BRIEF DESCRIPTION OF THE DRAWINGS

FIG. 1 illustrates an example environment in which an automated advising model hosting platform may be implemented.

FIG. 2 illustrates an example computing device usable to implement aspects of the present disclosure.

FIG. 3 illustrates an example flowchart of a method of operation of an automated advising model hosting platform, in accordance with example aspects of the present disclosure.

FIG. 4 is an example schematic of platform operation, according to example embodiments described herein.

FIG. 5 illustrates an example user interface useable by the platform described herein.

FIG. 6 illustrates an example user interface useable by the platform described herein.

FIG. 7 illustrates an example user interface useable by the platform described herein.

FIG. 8 illustrates an example top level set of scores generated by an example scoring model used by the platform described herein.

FIG. 9 illustrates an example user interface providing a valuation and recommendation feedback.

FIG. 10 illustrates an example valuation calculation model in which recommendation feedback adjusts a possible organization valuation, according to an example embodiment.

FIG. 11 illustrates an example user interface for inputting valuation metrics from a client organization, according to an example embodiment.

FIG. 12 illustrates an example user interface for inputting organizational details according to an example embodiment.

FIG. 13 illustrates an example user interface illustrating completion of data submission from a client organization, according to an example embodiment.

FIG. 14 illustrates a summary result page useable in aspects of the present disclosure.

FIG. 15 an example flowchart of a delta-based calculation process is provided, which is useable in accordance with aspects of the present disclosure.

FIG. 16 illustrates a dual weighting architecture that utilizes the scoring of FIG. 15.

### DETAILED DESCRIPTION

As briefly described above, embodiments of the present invention are directed to a platform that hosts an automated advising model. The platform includes a number of potential data integrations, including integrations with third-party data sets, including public data sets. These integrations enable access to granular business information usable for organizational benchmarking. The integration of such third-party data sets enables the platform to elicit information from an organization that is highly relevant in nature, and provide automated feedback to the organization regarding operational changes that might be made to improve organizational health according to stated organization goals.

In the example aspects, the platform may host software that organizes, analyzes, and presents data to assist small business owners and advisors in improving business performance and valuation. The platform as described herein utilizes highly granular industry specific models and applies granular scoring algorithms to generate recommendations for improvement of organizational performance. The scoring algorithms are modified to be sector-specific based on historical valuation data available from third party sources; relevant features are determined from the historical valuation data and used in a scoring model to generate the scores associated with the received information from the organization. The scores may be used to generate content and/or automate messages sent to entities, for example based on a change in score over time or a particular threshold being met. This enables more timely communication with organizations, enables rapid identification and presentation of relevant information, and otherwise increases customization of communication with organizational users.

In example implementations, input may be received by the platform, via one or more user interfaces, regarding a variety of aspects of an organization. Such aspects of the organization may include user input regarding prioritization of components of a business. These inputs may be weighted and scored according to predetermined and/or adjustable weightings based on comparatives to other business valuations of organizations having greater operational health.

Additionally, in the example implementations, some of the questions presented to an organization may be open ended inquiries regarding organizational priorities, but which may be used to assess business acumen of individuals in the organization. For example, prioritization regarding historical income areas for a business, expense areas for the business, and operational systems for the business, may be assessed. Regarding income issues, information may be gathered and guidance provided regarding recurring revenue, product mix, customer base, and like it may be analyzed. Regarding expense issues, information may be gathered and guidance provided regarding reduction of recurring expense ratios, reducing overall expense, controlling budget variance and reducing interest expense, as well as planning and management of technology expenses. Such factors are considered exemplary, and not limiting.

Regarding operations, improvements in outsourcing of unprofitable tasks, increasing automation, increasing revenue per employee, controlling or decreasing employee headcount, and systematizing processes such as marketing or other needed process, may be analyzed and results displayed.

In some implementations, a user may be enabled to input an overall goal of a automated advising process. The overall goal may relate to a particular goal of the organization, such as increasing overall valuation, improving profitability, improving operations, and the like.

In some implementations, a user may be enabled to input a particular industry or business segment in which there organization operates. The business segment or industry may be identified using an appropriate North American Industry Classification System (NAICS) code. Still further, using the NAICS code, historical valuation transaction data may be obtained from a further third party. For example, historical price/earnings ratios, valuations, and/or other financial status information of well-run companies may be obtained from a third party data source for use as a baseline comparator.

As will become apparent from the following disclosure, the platform described herein has a number of advantages over existing attempts at performing automated advising for business organizations. In particular, the methods described herein incorporate sector-specific data as part of a scoring model that may then be used to generate an overall score and a valuation of an organization. Additionally, in an automated fashion, an organization may receive feedback regarding potential recommended areas for operational improvements and an end-effect on valuation that may be achieved in response to making such improvements, which provides a simple, automated way to see the payoff of organizational change. Furthermore, the manner of calculation of valuation, particularly calculating particular valuations such as incorporating discount for lack of marketability (DLOM) or discount for lack of control (DLOC) analysis is greatly simplified. For example, by removing the requirement of detailed collection and calculation of specific intermediate valuations that would typically be required (e.g., as might occur in a restricted stock method, an IPO method, or an option pricing method of valuation), overall operation of the platform is simplified. This greatly streamlines, and reduces computational overhead of generating multiple valuations. This enables organizations to investigate those changes that will have maximum economic or organizational effect in an efficient manner, and enables higher usage by the increased number of entities that are able to leverage such a platform to effect organizational change.

Additionally, the platform as described herein has a number of technical advantages relative to existing advising platforms. For example, the present application utilizes a change-based, or delta-based analysis methodology to determine relative changes that may be able to be made by a given organization, which better identifies area for improvement as compared to absolute value changes. Still further, based on scoring being within or outside of predetermined ranges, scores or contributors to scores may be dynamically amplified such that the effect of a particular factor may be highlighted, with responsive actions to that scored attribute being highlighted in response thereto.

Still further, the platform described herein enables concurrent modeling of an organization according to different objectives, using different weighting schemas and criteria. For example, a technical feature of assessing an organization for two different intended outcomes (e.g., operating the organization as compared to a sale or transfer of the organization) improves useability of user interfaces, and provides parallel processing of data inputs in a manner that is highly efficient.

Finally, the inputs received from an organization, as well as third party inputs from tools utilized by the organization, may be automated so that data may be ingested in realtime. The combination of realtime data ingestion, automated assessment, and triggers of downstream communications enables a largely automated advising platform that addresses the computational challenges of enabling meaningful cross-organizational comparisons despite size differences. That is, the delta-based approach with dynamic amplification provides a technical solution that enables automated, scalable comparative analysis while maintaining valuation accuracy through realtime external data integration.

### A. Overall Platform Operation

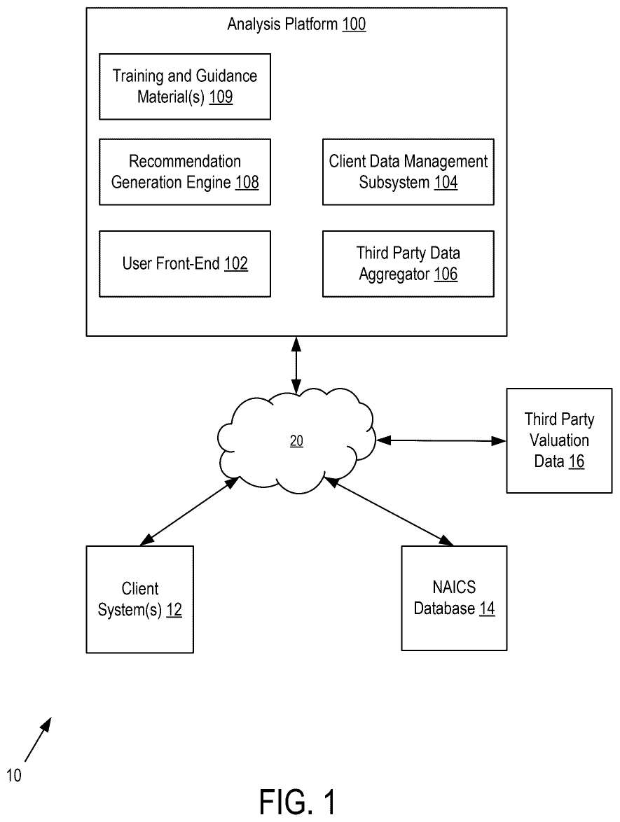

Referring to FIG. 1 an example environment 10 in which an automated advising model hosting platform may be implemented. The example environment 10 includes platform 100 that hosts an automated advising model. The platform 100 is communicatively connected to one or more client systems 12, as well as one or more third-party data systems, including a NAICS database 14 and third party data 16, via network 20.

The client systems 12, in the embodiment shown, include one or more computing systems of client organizations seeking automated advising via the platform 100. For example, the client systems 12 may be computing systems associated with one or more small or midsize organization seeking business consulting services, but which do not wish to engage in a manual consulting and valuation process. Such organizations may be those seeking to maximize a sale valuation or an operating evaluation by changing one or more operational processes within the organization.

The NAICS database 14 is a publicly available third-party database containing a set of business sector codes. The business sector codes may be used to identify other organizations having similar operations. For example, third party data 16 may include to data records associated with business operations of companies that are publicly available. For example, third party data may include data describing financial performance of other companies in a similar sector. This information may include market return data of large enterprises operating in a similar sector (e.g., based on S&P 500 average return over the last predetermined period), a baseline risk free return value (e.g., based on U.S. Treasury rates), and standard deviations of performance. Additionally, third party data 16 may include price-earnings multiples of publicly traded companies operating in the same or a similar business sector, annual volatility averages, and the like. Through use of the NAICS database 14, relevant business sector information may be obtained from the third party data 16, and used in modeling performed by the analysis platform 100 to generate a custom evaluation and recommendations for client organizations within the same or a similar sector.

In the example shown, the platform 100 includes a user front end 102, a client data management subsystem 104, a third party data aggregator 106, and a recommendation generation engine 108.

The user front end 102 presents a guided information collection interface, for example via a web interface, to the client systems 12 via the network 20. The user front end 102 may also present one or more user interfaces to provide feedback, valuation, and guidance materials to the client systems 12 based on a valuation and assessment of the client organizations accessing the platform 100.

The client data management subsystem 104 receives and retains client data in response to prompts presented at the user front end 102. The prompts, presented in one or more web interface screens, request information regarding organizational goals, operating sector information of the organization, and various responsive information regarding organizational components corresponding to financial, operational, and leadership performance within the organization. Example details of such prompts are discussed in further detail below.

The third-party data aggregator 106 maintains an interface (e.g., via API or other means) to the NAICS database 14 and to the third party data 16. In response to receipt from a client of sector information, a corresponding NAICS code may be obtained and used to retrieve relevant third party data 16 regarding financial performance of organizations that are similarly situated within the same sector. Third party financial information may be representative of historical price-earnings and valuations of well-run companies similarly situated to companies being evaluated by the platform. In some instances, this information may be used as a baseline for valuation of privately-held organizations, with adjustments made to the companies that are evaluated and scored based on operational details, as well as discounts for lack of marketability and/or control. The third-party data aggregator 106 provides this information to the recommendation generation engine 108, which uses it, alongside data from the client data management subsystem 104 (as received at user front end 102) to perform scoring and validation processes regarding the organization, as described below.

The third-party data aggregator 106 may perform an API call to obtain third party data; in alternative implementations, the third-party data aggregator 106 may be implemented as a scraping tool useable to gather relevant NAICS data, and public information from a plurality of data sources regarding performance of public third party entities operating in accordance with a variety of NAICS classifications that may subsequently be used for automated comparative analysis.

In some instances, the third-party data aggregator 106 maintains real-time API connections to external valuation databases, including BVR systems that provide dynamically updated discount rates based on actual company transaction data. The system implements automated data refresh processes to ensure sector-specific weightings reflect current market conditions, with discount rates “changing all the time” based on ongoing transaction activity within each business sector.

In particular examples, the recommendation generation engine 108 hosts a scoring model, which has features that may be customized based on the third-party data 16. In some examples, questions may be asked via the user front end 102, and responses may be weighted and scored differently, depending on the sector information received from the client.

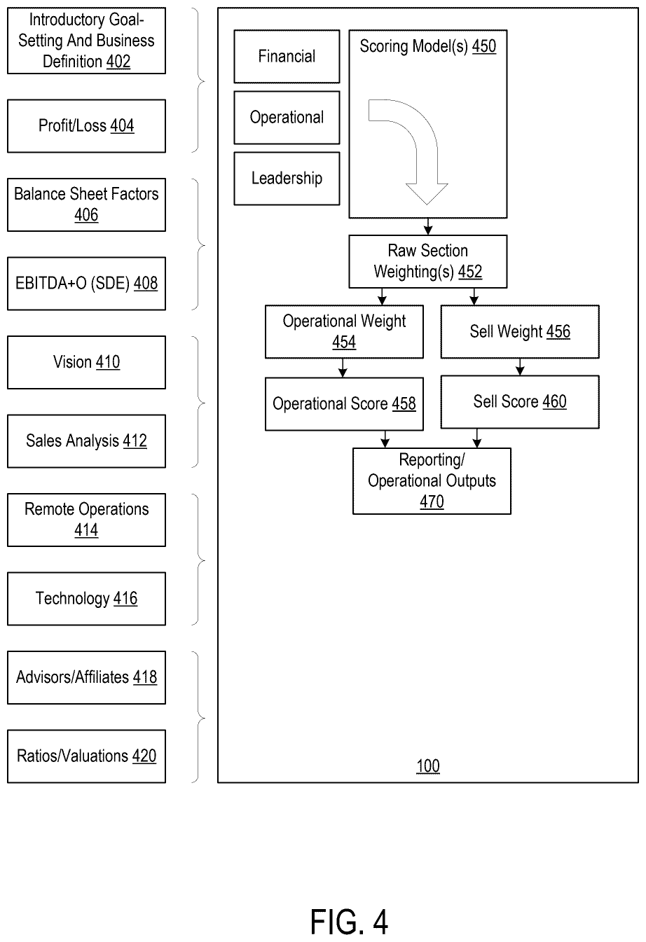

In some instances, responses from the client user may be scored individually or in categories or general areas of response, e.g., depending on whether the response relates to financial, operational, or leadership aspects in a wide variety of business areas (examples of which are provided below in conjunction with FIG. 4), Responses may be scored differently at the scoring model based on weights assigned to the scoring model. The weights are defined in accordance with features that may be determined to be relevant to operational performance. Based on the scores assigned to the response information from the client, a valuation process is performed at the platform, thereby determining an overall score from the plurality of scores. The platform 100 also generates one or more valuations of the organization based on the overall score and organizational goals. The one or more valuations may include a sales valuation (e.g., in the case the client wishes to sell the organization) and a cash flow valuation (e.g., in the case of the client wishes to continue operating the organization).

In some embodiments, the platform further includes a delta calculation engine configured to transform absolute organizational metrics into comparative delta values by calculating percentage changes over predetermined time periods. The delta calculation engine operates in conjunction with a dynamic amplification module that applies magnitude-based adjustments to initial scores derived from the delta values.

In some examples as described below, the platform further presents to the client user one or more recommendations regarding operational changes that may be made to the organization. The one or more recommendations may be identified based on low performing scores identified from responses to questions and the sector specific weighting. The client may be presented, via user front end 102 recommendations regarding operational changes that might be made, as well as a potential change in valuation that could occur in response to making such changes. An example of such a recommendation and valuation change is described further below; generally speaking, this enables the user to readily see the return on investment regarding organizational change.

In some instances, based on inputs from the client user, that client user may be referred by the platform to training and guidance materials 109. The training and guidance materials may include segmented portions of trainings presentable to the client user based on their responsive information provided. For example, a particular client user may be scored low in an area such as organizational process automation, and may be routed to a training unit regarding business process optimization. Another client user may be scored low in an area such as information technology or professional services, and may be routed to training units directed to those business components.

In some further examples, as a client may change operations of an organization or may sell the organization, additional data regarding the organization may be captured and stored at the client data management subsystem 104. This information may correspond to improved financial performance of the organization, or a particularized valuation defined by a sale price of the organization. Such information may be used in combination with the third party data 16, to further inform the weightings applied to the scoring model for that client or other clients. In some examples, different weightings may be applied concurrently to generate multiple outcomes or scenarios, depending on a desired manner of operation of the organization (e.g., sale or operation).

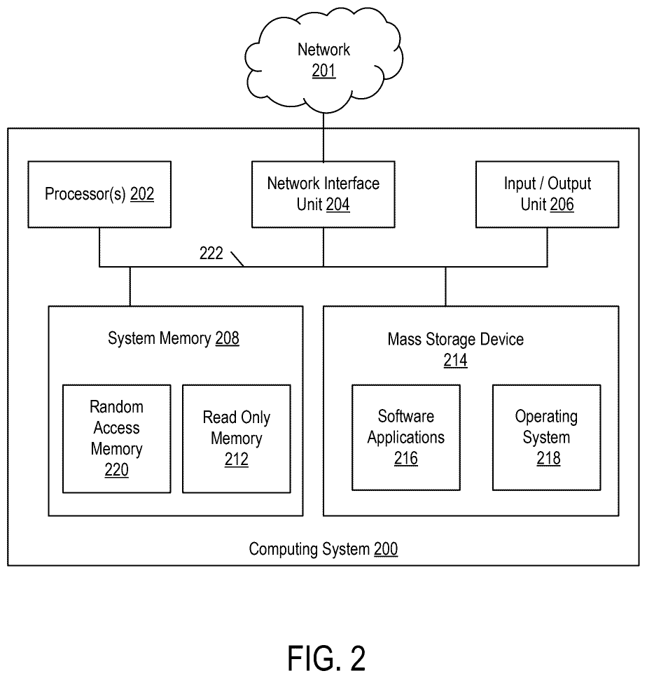

FIG. 2 illustrates an example block diagram of a virtual or physical computing system 200. The computing system 200 may be used to implement the platform 100, as well as client systems 12, and third party systems such as the NAICS database 14 and third party data 16. One or more aspects of the computing system 200 can be used to implement the processes described herein.

In the embodiment shown, the computing system 200 includes one or more processors 202, a system memory 208, and a system bus 222 that couples the system memory 208 to the one or more processors 202. The system memory 208 includes RAM (Random Access Memory) 210 and ROM (Read-Only Memory) 212. A basic input/output system that contains the basic routines that help to transfer information between elements within the computing system 200, such as during startup, is stored in the ROM 212. The computing system 200 further includes a mass storage device 214. The mass storage device 214 is able to store software instructions and data. The one or more processors 202 can be one or more central processing units or other processors.

The mass storage device 214 is connected to the one or more processors 202 through a mass storage controller (not shown) connected to the system bus 222. The mass storage device 214 and its associated computer-readable data storage media provide non-volatile, non-transitory storage for the computing system 200. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 200.

According to various embodiments of the invention, the computing system 200 may operate in a networked environment using logical connections to remote network devices through the network 201. The network 201 is a computer network, such as an enterprise intranet and/or the Internet. The network 201 can include a LAN, a Wide Arca Network (WAN), the Internet, wireless transmission mediums, wired transmission mediums, other networks, and combinations thereof. The computing system 200 may connect to the network 201 through a network interface unit 204 connected to the system bus 222. It should be appreciated that the network interface unit 204 may also be utilized to connect to other types of networks and remote computing systems. The computing system 200 also includes an input/output controller 206 for receiving and processing input from a number of other devices, including a touch user interface display screen, or another type of input device. Similarly, the input/output controller 206 may provide output to a touch user interface display screen or other type of output device.

As mentioned briefly above, the mass storage device 214 and the RAM 210 of the computing system 200 can store software instructions and data. The software instructions include an operating system 218 suitable for controlling the operation of the computing system 200. The mass storage device 214 and/or the RAM 210 also store software instructions, that when executed by the one or more processors 202, cause one or more of the systems, devices, or components described herein to provide functionality described herein. For example, the mass storage device 214 and/or the RAM 210 can store software instructions that, when executed by the one or more processors 202, cause the computing system 200 to implement an automated advising platform.

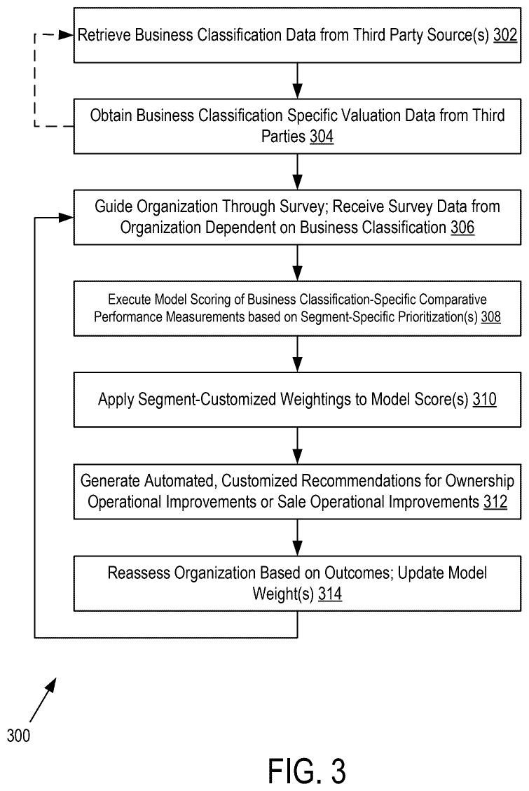

FIG. 3 illustrates an example flowchart of a method 300 of operation of an automated advising model hosting platform, in accordance with example aspects of the present disclosure. The method 300 may be performed using the platform 100 described above, and includes method steps 302-314.

In the example shown, the method 300 includes retrieving business classification data from third-party sources (step 302). Retrieving the business classification data from third-party sources may include retrieving NAICS codes from an NAICS database 14. The method 300 further includes retrieving transaction records and operating records of organizations from third party data 16 that are relevant to a particular identified client's NAICS codes (step 304).

In the example shown, the method 300 includes guiding an organization through an information retrieval process, for example via a questionnaire or survey (step 306). As part of this, the method includes receiving survey data from the organization, wherein the survey data corresponds to operational performance, leadership performance, and financial performance of the organization. In some examples, the questions are specific to an operating segment associated with the business. In alternative examples, the questions are generally applicable across all businesses, but one or more of either (1) weightings or (2) valuations may applied to the responses in a manner that is specific to the business or business segment.

In the example shown, the method 300 includes executing model scoring based on segment specific model weights in response to the received information from the organization (steps 308, 310). In particular, responses may be scored, and the scores assigned to each response may be weighted according to segment customize weightings. Based on the weightings, a valuation process may be performed to generate a valuation for the organization, as well as one or more customized recommendations regarding ownership operational improvements or improvements to achieve an increased sale valuation (step 312). The valuation process may generate one or both of an operational valuation or a sale valuation, and is derived from financial performance of the organization as provided by the client, comparative information from the third party data 16, and scores obtained via the interaction with the client and the model weightings applied to the scoring model. The various score weightings, which are applied across financial performance, operational performance, and leadership criteria, are aggregated into an overall score which informs organizational valuation.

In a particular example, an average revenue of the organization may be used as a baseline, and a maximum valuation of the organization may be determined from (1) comparable organizations (e.g., from third party data), and (2) any discounting to be applied, for example due to lack of marketability or control. A score for each of a plurality of areas of operational performance may be determined, and the maximum valuation may be adjusted in response thereto. Based on the weighting of questions as relative to the overall adjusted valuation and maximum valuation, improvement in response to each question may adjust an overall valuation by a predetermined number, so the client user may instantly see a valuation effect of an organizational change. Similarly, profitability may be calculated rather than revenue, if concerned with cash flow rather than valuation. In such an instance, average profit may be used, and discounted by an overall organizational score across all operating areas. Based on the score and current profits, a theoretical maximum profit may be determined. Based on the theoretical maximum profitability and a weighting of each score within each category and/or question, organizational improvements may be valued in terms of potential effect on profitability and presented to the user as well. It is noted that the weighting for profitability may differ from a weighting for valuation across the various questions, as responses to each question may suggest a factor having a greater or lesser effect on such metrics, at least somewhat independently.

In some examples, as an organization continues to make changes and request reevaluation, the organization may be reassessed based on those changes, and revised valuations may be provided. Furthermore, based on new transactions associated with the organization (e.g., a sale of the organization or sales of other organizations), model parameters and weightings may be updated to improve performance of the scoring model and overall valuation process (step 314).

Accordingly, the methodology provided in FIG. 3 enables a client user to solve a number of problems concurrently-determining a likely organization valuation using a baseline of available publicly traded organizations and adjusted by (1) discounting due to lack of marketability and/or control, and (2) discounting based on weighted factors determined from operational performance of the organization based on client user inputs and sector-specific valuations and weightings. By doing so in a highly granular manner across a variety of data categories, separate valuation changes may be estimated for each organizational change to be made by a client user, so that client user may readily be presented with the impact that an organizational change might make on cash flow and/or valuation of that client organization.

FIG. 4 is a schematic view of an example platform operation as described herein. In the example shown, the platform 100 receives various information from a client organization, including introductory goalsetting and business definition information 402, profit loss information 404, balance sheet factor information 406, EBITDA and related information 408, organizational vision information 410, sales analysis information 412, remote operations information 414, technology information 416, advisor and affiliate information for 18, and ratios or valuation information 420.

In examples, the introductory goalsetting and business definition information 402 may include requests for a last five years of profit and loss statements, a balance sheet statement, income goals, expense goals, operational goals and business phase information. The introductory goal setting and business definition information 402 may also include a request to rank particular pieces of advice received in terms of importance, timing of retirement of key operating entity individuals, and an identification of a sector or industry in which the business operates, including receipt of an NAICS code.

The profit loss information 404 may include information regarding gross revenue each year over the last five years, cost of goods sold each year over the last five years, cost of goods sold as a percentage of revenue, gross profit for the last five years, compensation paid to employees or contractors within the same period, as well as marketing, operations, and professional advice spend trends. Additionally, the profit loss information 404 may include information regarding technology spend, interests, and taxes paid over the last five year period, as well as depreciation, amortization, and net profit within similar time frames.

The balance sheet factor information 406 may include information regarding bank account balances at the end of each year, investment account balances, receivables, accumulated depreciation, total assets, short-term depths, long-term debts, retained earnings, total liabilities, and owner equity over a five-year period.

The EBITDA and related information 408 may include carnings information requests, interest information requests, tax information requests, depreciation requests, amortization requests, EBITDA, and owner distributions, owner hours worked, and replacement cost of ownership/leadership processes. In some instances, the information for one or more of these data elements may be requested from the user; in other instances, this information may be calculated from responses received in association with other categories of information requests from the client.

The organizational vision information 410 may include information regarding how long the organization has been operating, the desired timeframe for the organization, short-term goals, long-term goals, and a ranking thereof. Additional information, such as desired outcome for the organization and ranked priorities may be received as well.

The sales analysis information 412 may include a sales report, a revenue generation report, a percentage of revenue generated by top customers, percent of customer account change annually, repeat customer information, revenue per customer, annually recurring revenue, and the like, over a prior five-year period.

The remote operations information 414 may include information regarding the amount of time spent working in a physical office, amount of time spent working remotely, the extent to which remote work impeded the ability for the organization to operate effectively, number of support staff, revenue generated per support staff member, extent of virtual staff use, ability to automate business process, and ability to recover from physical disaster at a place of business.

The technology information 416 may include information regarding a technology budget, specific software platforms used, how IT resources are managed, number of backup locations for data, security of data, cyber insurance information and age of computer hardware, and business performance attributable to e-commerce or social media.

The advisor and affiliate information 418 may include information regarding use of legal services, insurance services, investment advisement services, tax services, financial statement assessment services, human resources services, licensing consultancies services, technology consulting services, and the like

The ratios or valuation information 420 may be automatically calculated from prior inputs, and may include profit and loss ratios, balance sheet ratios, EBITDA trends, income trends, expense trends, asset trends, sales analysis trends, operations trends, technology trends, and the like. Such trends may be calculated from the past five year data received, and may result in an assessment of percentage increase, decrease, or steady operational performance.

The various information received is based on one or more of a set of categories relating to financial, operational, and leadership features of the organization, and are provided to one or more scoring models 450. Each response received from the organization may be scored. The one or more scoring models are assigned weights that are sector specific, and as such, the information received may be scored in a customized manner for the organization within the sector. The scoring models 450 output raw section weightings 452, which are then extrapolated into an operational weighting 454 or a sell weighting 456, or both. This results in an overall operational score 458 or a sell score 460. The operational score or sell score may be used in generating a valuation. The valuation may be generated based on a sell or cash flow valuation, and may be done based on an initial valuation and discount for lack of marketability or control, followed by scaling based on weighting of question responses. Presentation of an end score and/or valuation are described below. In particular, a current valuation of the organization, as well as recommendations for improvement of organizational performance and accompanying improvements in valuation, may be generated and output to the client via the front end described in FIG. 1.

### B. Platform Interfaces

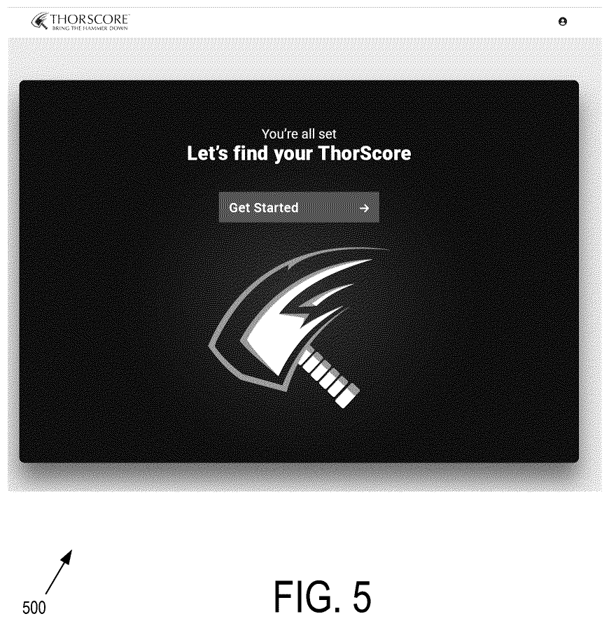

FIGS. 5-11 illustrate further example details of the platform 100, including user interfaces and model details that may implement the automated advising provided therein. FIG. 5 illustrates an example user interface 500 useable by the platform described herein. The user interface 500 represents an introductory screen presented by the platform at the client front end 102. The introductory screen may include a link to initiate an assessment of the client organization, and/or may include a link to guidance and training materials 109 as shown.

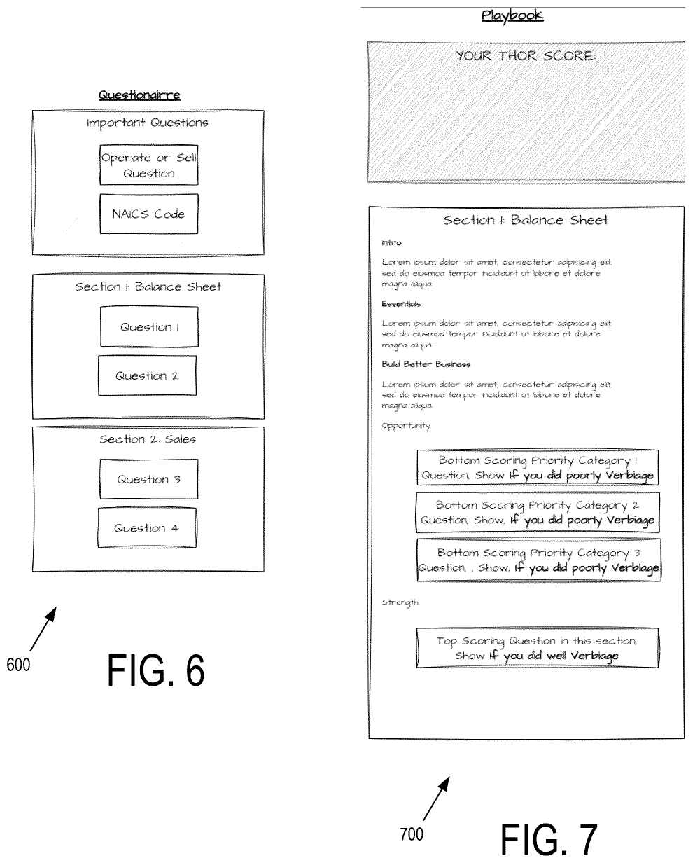

FIG. 6 illustrates an example user interface 600 useable by the platform described herein. The user interface 600 illustrates an example of a prompt presented to the user to provide responses to questions including introductory questions regarding goals of the organization (e.g. to continue to operate or sell) as well as a prompt to receive sector information in the form of an NAICS code. Additionally, the user interface 600 presents question regions in which a user may enter responses to questions that elicit the information described above in conjunction with FIG. 4.

FIG. 7 illustrates an example user interface 700 useable by the platform described herein. The user interface 700 illustrates a result of user entry of information in response to the series of questions presented in FIG. 6. In particular, and an overall score region is presented, as well as a set of section regions. Each section region may include portions that show the lowest scoring questions within that section, as well as, in some instances, a top scoring question in that section. In this section, custom messages may be presented to the user based on the responses provided, and in particular based on the specific areas in which the client user has done well (reached or approached a maximum score to maximize profit or valuation) or where the client user has opportunity for improvement.

Additionally, as illustrated, each of the pieces of information received in response to queries may be individually scored, and the lowest scores are identified. The user interface 700 presents those areas in which lowest scores were received, and may be used to highlight a particular advice section of a “playbook” that may be referred to by the client organization to identify potential operational improvements to be made (e.g., within the guidance and training materials 109 of FIG. 1).

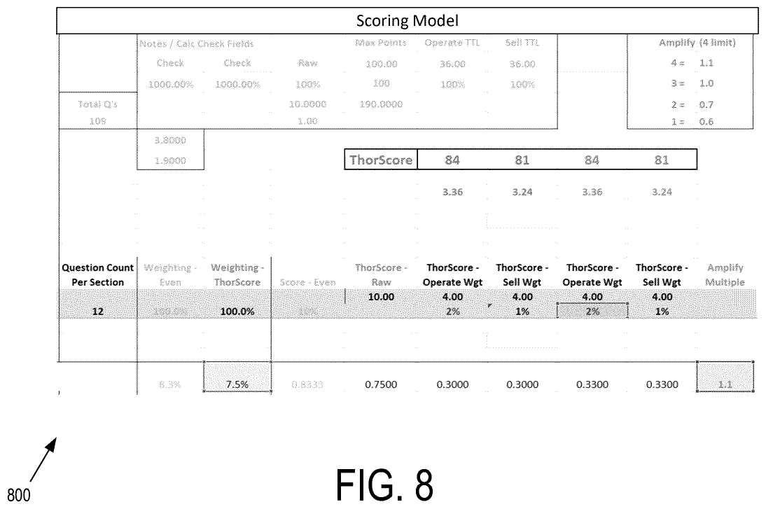

FIG. 8 illustrates an example top level set of scores 800 generated by an example scoring model used by the platform described herein. The scores 800 illustrate separate weightings for operating or selling an organization, as well as raw scores regardless of desired client outcome. The scores obtained from responses to questions are then used to generate a valuation (seen further below) based on a multi-variable derivative problem using weights and features specific to the business sector.

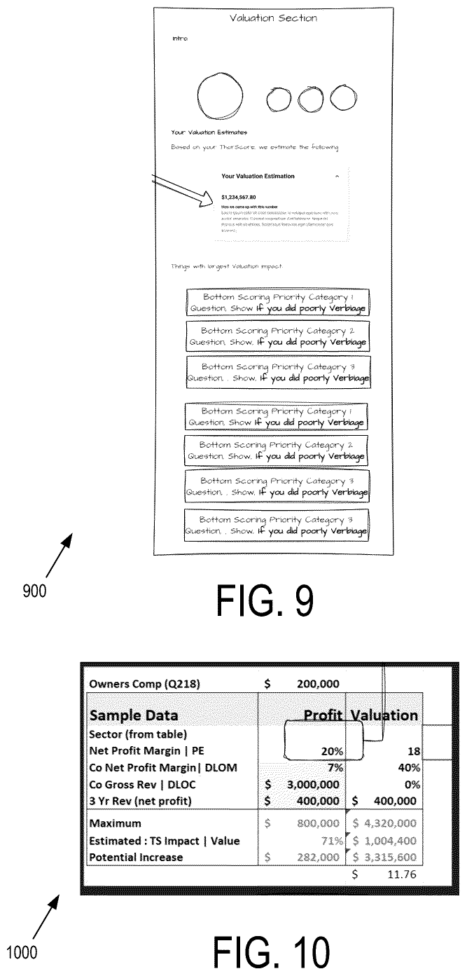

FIG. 9 illustrates an example user interface 900 providing a valuation and recommendation feedback. The user interface 900 is presented to the client, and illustrates the calculated valuation performed in response to the valuation process. The evaluation includes an explanation of how it is arrived at, as well as a set of lowest scoring areas of the organization. The set of low-scoring areas of the organization are in response to the questions presented as described above in conjunction with FIGS. 4 and 6, and may include recommendations for improving performance of the organization.

It can be seen in the example of FIG. 9 that the platform described herein may generate customized insights for an organization in an automated way. The insights are also actionable; by presenting not only a valuation and specific factors that might be improved, but also a quantitative assessment of which factors are most important and the impact that improvement may have on organizational cash flow or valuation, the user is better able to make decisions about how to prioritize organizational improvements. At the same time, detailed modeling of the organization is not specifically required to arrive at a valuation, since the valuation is generated based on a baseline of similarly-situated organizations for which public data is accessible.

FIG. 10 illustrates an example valuation calculation model 1000 in which recommendation feedback adjusts a possible organization valuation, according to an example embodiment. The valuation calculation model 1000 enables the underlying platform 100 to perform what if analysis on the organization to determine an effect of changes in the one or more low-scoring categories. As illustrated, changes in profit margin, net profit margin, and/or gross revenue may adjust overall valuation, and the adjustments to profit margin may be derived from operational improvements in e.g., staffing, outsourcing, technology features, and the like based on the information provided by the client.

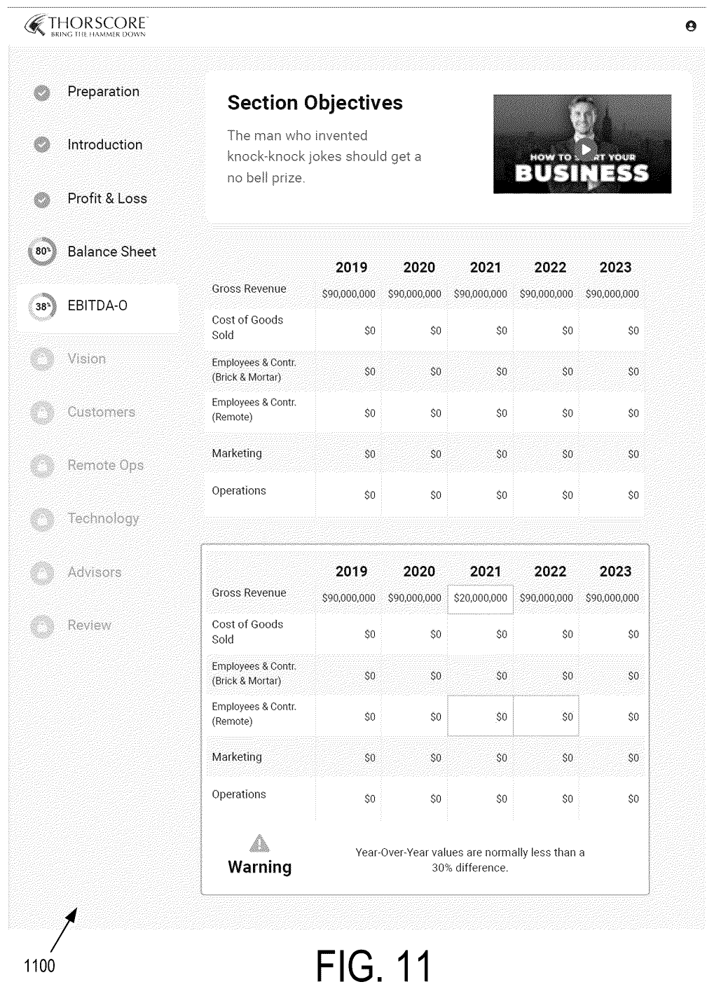

Referring to FIGS. 11-14, a set of more specific user interfaces are shown illustrating example aspects of the processes described above. FIG. 11 illustrates an example user interface 1100 for inputting valuation metrics from a client organization, according to an example embodiment. As shown, a user is prompted to input various information, including introductory information, profit and loss information, balance sheet information, EBITDA information, vision information, customer information, remote operations information, technology information, and advisor information. Each section is monitored automatically to determine a level of completeness, which may be displayed. In the specific example shown, a user interface depicts input of balance sheet and earnings information, and elicits information from the user relevant to those topics.

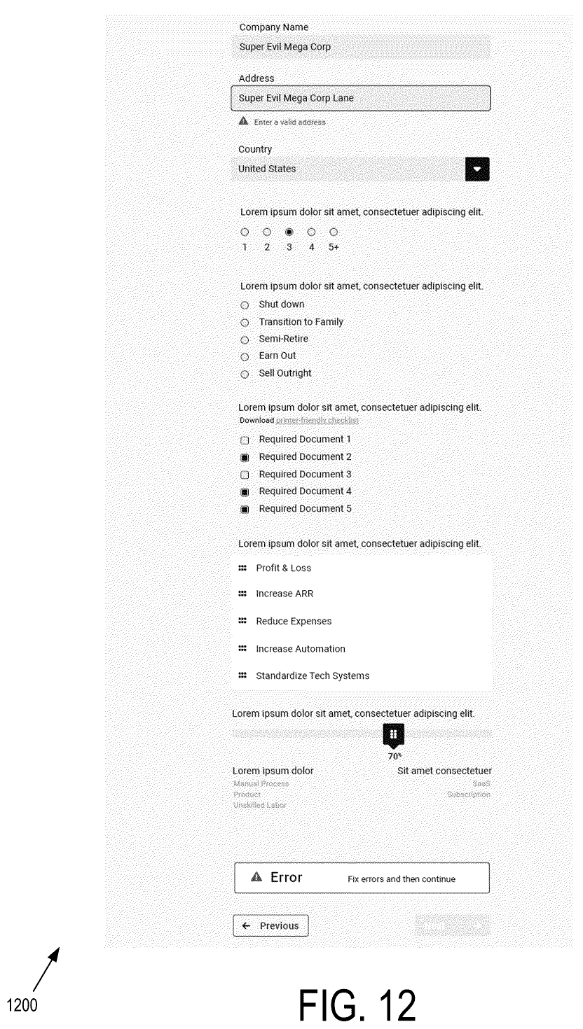

FIG. 12 illustrates a further example user interface 1200 for inputting organizational details according to an example embodiment. The user interface 1200 receives information about the organization, such as a name, address, goal setting, document information, and general goals. Additionally, a level of control (e.g. an ownership percentage) may be received as well. It is noted that in conjunction with the user interfaces of FIGS. 11-12, other user interfaces may be presented to elicit the types of information outlined above, for example in conjunction with FIGS. 3-4.

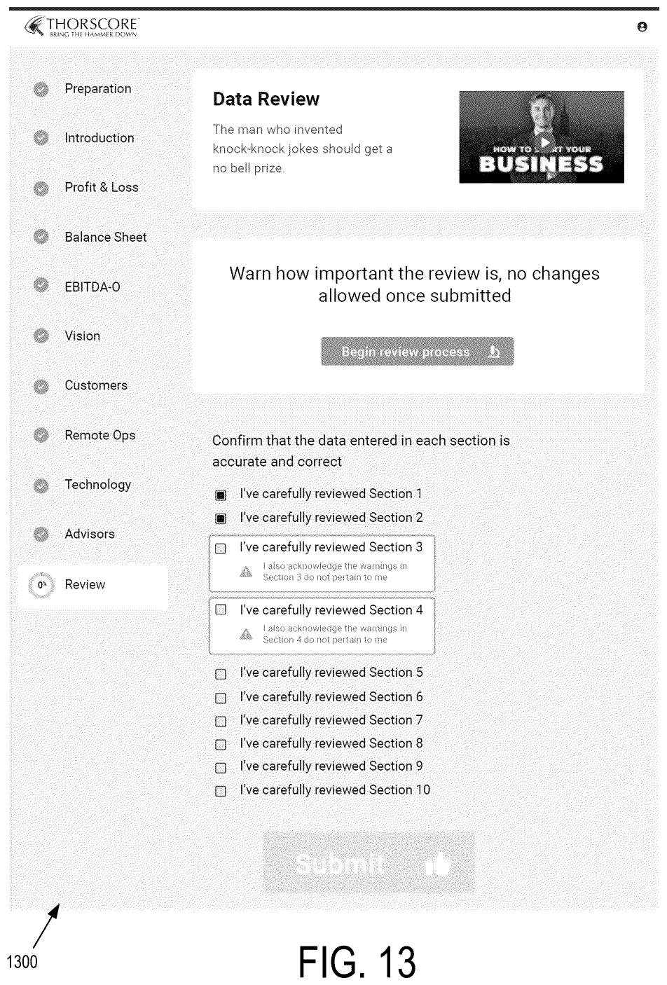

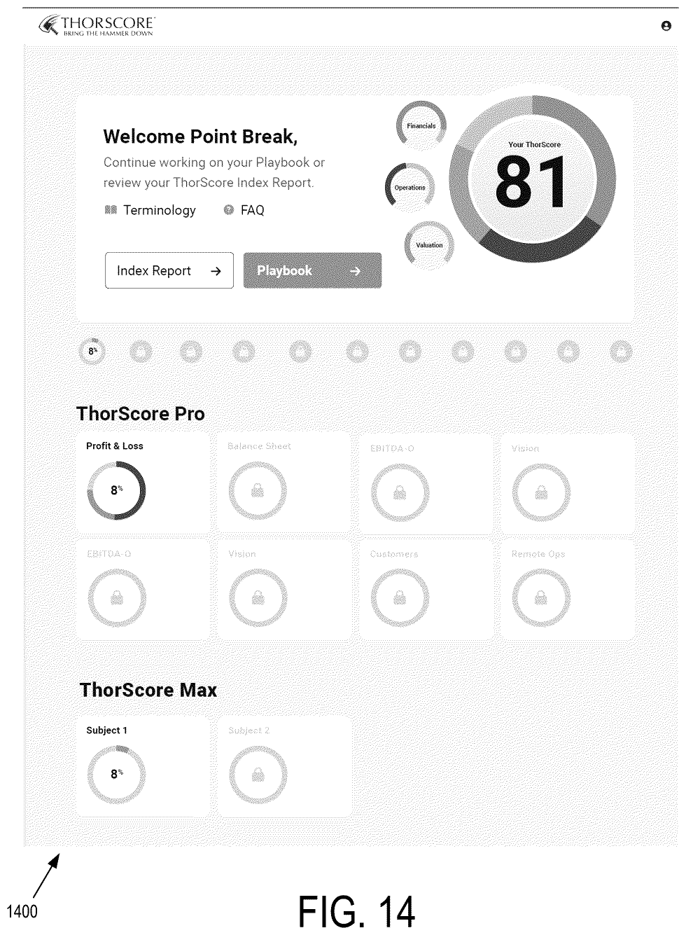

Upon completion, a further example user interface may be displayed, such as is shown in FIG. 13. As illustrated, a user interface 1300 requests that a user review each section for completeness and to address any warnings that may arise due to incomplete data or inconsistent data within the various sections. Upon completion, a further user interface, such as shown in FIG. 14, may be depicted that shows an overall score of the organization, as well as scores within each subsection of information received. The user interface 1400 also may present a link to a playbook (e.g., included in the information 109 of FIG. 1) and/or a customized report useable by the organization, which may include the valuation information described previously.

### C. Detailed Analysis and Data Processing Features

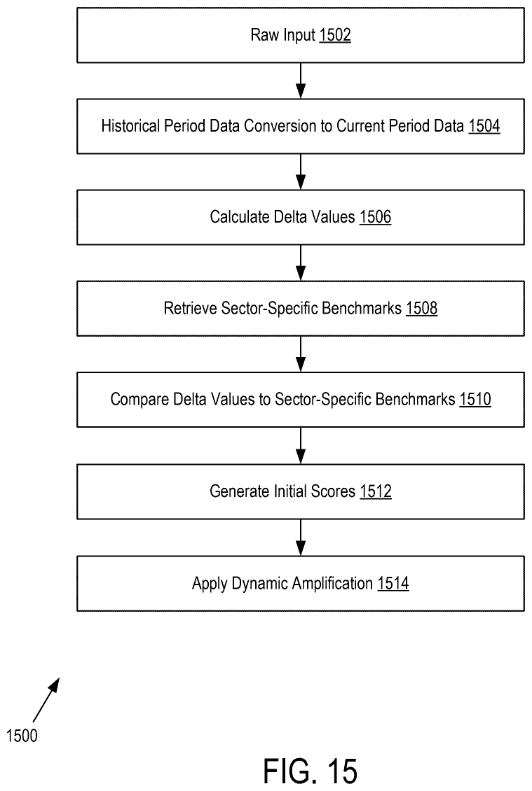

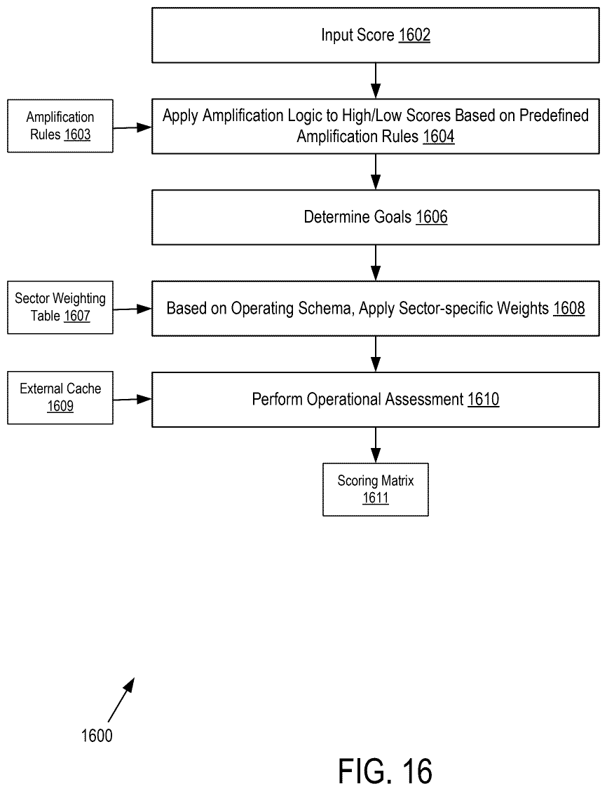

Referring now to FIGS. 15-16, additional details regarding the platform of the present disclosure are provided, which illustrate technical advantages thereof.

Referring first to FIG. 15, an example flowchart of a delta-based calculation process 1500 is provided. As illustrated, a delta calculation engine is configured to transform absolute organizational metrics into comparative delta values by calculating percentage changes over predetermined time periods. The delta calculation engine operates in conjunction with a dynamic amplification module that applies magnitude-based adjustments to initial scores derived from the delta values. The modules may be implemented as part of models 450 of FIG. 4, above.

FIG. 15 illustrates the comprehensive delta-based calculation architecture that enables meaningful cross-organizational comparisons regardless of company size differences. This technical approach addresses the computational challenge of comparing organizations with vastly different absolute values by converting raw metrics into comparative percentage-change values.

In the example shown, the process 1500 includes raw input processing of realtime data (step 1502). The system receives organizational performance data spanning multiple time periods, typically covering a five-year historical range. This raw input includes financial metrics such as gross revenue, profit margins, operational expenses, and key performance indicators specific to the organization's NAICS-classified sector.

In the example shown, the process 1500 further includes a conversion process (step 1504) in which a temporal data normalization process is performed that standardizes historical period data against current period data. This conversion process accounts for seasonal variations and business cycle adjustments, ensuring that delta calculations reflect meaningful performance trends rather than cyclical fluctuations.

In the example shown, the process 1500 further includes a delta value generation process in which the platform calculates percentage change values rather than using absolute numbers. For example, rather than comparing Organization A's $500,000 annual revenue against Organization B's $10,000,000 annual revenue, the system compares their respective revenue growth percentages over the same time period. This delta-based methodology enables direct comparison between organizations of different scales while maintaining valuation accuracy.

In the example shown, the process 1500 further includes sector-specific benchmark retrieval (step 1508). The platform 100 maintains real-time API connections to external valuation databases, including BVR systems that provide dynamically updated discount rates based on actual company transaction data. The benchmark retrieval process utilizes NAICS codes to obtain sector-specific performance standards, with discount rates “changing all the time” based on ongoing transaction activity within each business sector.

In the example shown, the process 1500 further includes a comparison process (step 1510), in which calculated delta values undergo comparative analysis against retrieved sector-specific benchmarks. This process implements automated data validation and ensures that organizational performance metrics are evaluated within appropriate industry contexts rather than against generic business standards.

In the example shown, the process 1500 further includes an initial score generation (step 1512). Based on the comparative analysis, the platform assigns initial scores on a predetermined scale (typically 1-4) using range-based scoring thresholds. The scoring algorithm incorporates sector-specific importance weightings that reflect the relative significance of different performance metrics within the organization's industry classification.

In the example shown, a dynamic amplification mechanism (step 1514) applies magnitude-based amplification factors to create enhanced differentiation between high-performing and low-performing metrics. Scores meeting or exceeding high performance thresholds (e.g., score of 4) receive positive amplification factors of approximately 10%, resulting in amplified scores of 4.2 to 4.4. Conversely, scores at or below low performance thresholds receive negative amplification factors, reducing scores to approximately 0.8.

FIG. 16 illustrates a dual weighting architecture 1600 that utilizes the scoring of FIG. 15, enabling the platform to generate different assessments based on organizational objectives while utilizing the same underlying performance data. In the example shown, this includes an input score processing stage (1602) in which amplified scores from the delta calculation engine (FIG. 15) are received and prepared for goal-oriented weighting application. The input scores maintain their sector-specific context and amplification adjustments throughout the weighting process.

In the example shown, an amplification rules table 1602 stores score range thresholds and corresponding amplification factors. The rules engine maintains separate amplification profiles for different NAICS codes and organizational contexts, enabling dynamic adjustment of score differentiation based on industry-specific performance expectations. Dynamic amplification logic 1604 applies programmable amplification factors based on predefined rules that target high and low performance ranges. The amplification logic operates selectively: high-performance scores receive positive amplification to emphasize excellence, while low-performance scores receive negative adjustments to highlight areas requiring improvement. Mid-range scores typically remain unchanged to maintain baseline comparison validity.

In the example shown, a goal determination operation 1606 automatically detects organizational objectives based on user input during the initial assessment phase. The platform differentiates between “operate” goals (continuing business operations) and “sell” goals (preparing for business sale), with this determination triggering appropriate weighting schema selection. In some implementations, both sets of goals, and appropriate weightings, may be applied in parallel to more quickly generate a plurality of operative scenarios for assessment.

In the example shown, a set of sector weighting tables 1607 is maintained, organized by NAICS codes and goal types. These sector weighting tables store sector-specific weights that reflect the relative importance of different performance factors for operational success versus sale readiness within each industry classification. A weight application process 1608 applies, based on the organizational goal determination, one or both of an operational weighting schema or sale-oriented weighting schema. Operational weightings prioritize long-term operational efficiency, process optimization, and sustainable growth metrics, while sale-oriented weightings emphasize factors most relevant to business valuation and marketability, including financial performance consistency and operational transferability.

In the example shown, an external data cache 1609 is provided that maintains a high-performance caching layer for external API responses, implementing automated refresh cycles to ensure sector-specific weightings reflect current market conditions. The cache includes time-to-live (TTL) values and fallback mechanisms to maintain system responsiveness even when external data sources are temporarily unavailable.

The external data cache 1609 and weighted scores are provided to the assessment generation process 1610 which performs final score aggregation using the goal-specific weighted values to generate comprehensive organizational assessments. This process enables parallel generation of both operational and sale-oriented evaluations, providing users with comparative analysis of their organization's performance across different strategic objectives.

In the example shown, a scoring matrix 1611 maps response ranges to assigned scores based on sector-specific criteria and goal types. These matrices enable rapid score calculation while maintaining consistency across different organizational assessments within the same industry classification. The scoring matrix 1611 may define specific trigger features to cause to occur, including automated messages, recommendations, or reporting as described above in conjunction with FIGS. 5-11. It is noted that those user interfaces may be revised in realtime based on the information as updated.

Referring to the disclosure overall, it is noted that a number of technical advantages are realized. For example, unlike traditional business valuation systems that rely on absolute metric values, the platform implements a delta-based methodology that transforms raw organizational data into comparative percentage-change values, enabling meaningful cross-organizational comparisons regardless of company size differences. This approach solves the fundamental computational challenge faced by existing systems when attempting to compare a $500,000 revenue organization against a $10,000,000 revenue organization by focusing on growth trajectories rather than absolute values.

The platform's dynamic amplification system creates differentiation between high-performing and low-performing organizational metrics through programmatic application of magnitude-based adjustments. Scores meeting high performance thresholds receive positive amplification factors of approximately 10%, while low-performance scores receive negative adjustments, expanding the scoring range to provide more precise differentiation between organizational performance levels. This technical approach enables the system to emphasize critical performance factors automatically based on sector-specific importance weightings.

Additionally, realtime external data integration, including active API connections to Business Valuation Resources (BVR) and other third-party databases, provide dynamically updated discount rates based on actual company transaction data. Unlike static valuation approaches, these discount rates change consistently based on ongoing market activity, ensuring that organizational assessments reflect current market conditions rather than outdated benchmarks. The system implements automated data refresh processes with intelligent caching mechanisms and fallback procedures to maintain responsiveness even when external data sources experience temporary availability issues.

Still further, the dual weighting schema architecture enables efficient generation of multiple assessment perspectives from a single data collection cycle, automatically applying different algorithmic weightings based on organizational goals without requiring separate assessment processes. When users indicate operational improvement objectives, the system prioritizes long-term efficiency and sustainable growth metrics, while sale-preparation goals trigger weightings that emphasize valuation-relevant factors such as financial consistency and operational transferability. This technical capability eliminates computational overhead while providing comprehensive analytical coverage.

The platform's modular architecture supporting external caching, rule-based amplification, and structured weighting tables enables scalable operation across multiple industry sectors without requiring fundamental architectural changes. The delta calculation engine processes temporal data spanning multiple periods, automatically normalizing for seasonal variations and business cycle adjustments to ensure meaningful trend analysis. Combined with sector-specific NAICS code integration, this creates a highly responsive system that delivers automated, sector-customized comparative analysis while maintaining valuation accuracy through continuous external data synchronization.

These technical implementations provide improvements over existing manual valuation processes by automating complex comparative analysis, eliminating the computational complexity of processing multiple external data sources simultaneously, and solving the scalability limitations inherent in traditional consulting approaches. The result is a platform capable of delivering sophisticated business valuation analysis with the speed and consistency of automated systems while maintaining the analytical depth previously available only through expensive manual consulting engagements.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of advising platforms, technologies disclosed herein are applicable to data and methods for determining valuations and providing organizational performance advising generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method of providing automated advising to an organization regarding business valuation, the method comprising:
presenting, at a web interface, a guided information collection interface, the guided information collection interface presenting a series of screens requesting information regarding organizational goals, operating sector information, and responsive information regarding a plurality of organizational components corresponding to at least one of financial, operational, and leadership performance;
receiving response inputs at the web interface from the organization;
based on the operating sector information, obtaining third party records providing historical third party financial data associated with the operating sector;
weighting a scoring model in accordance with features determined to be relevant to operational performance from the historical third party financial data;
generating a plurality of scores in response to the responsive information based on the scoring model; and
based on the plurality of scores, performing a valuation process at an organizational advising platform, the organizational advising platform determining an overall score from the plurality of scores and generating one or more valuations of the organization based on the overall score and the organizational goals;
wherein the one or more valuations are generated based on the responsive information and the plurality of scores.

2. The method of claim 1, wherein the valuation is based on a discount for lack of marketability (DLOM) analysis.

3. The method of claim 2, wherein the valuation is performed without requiring use of a restricted stock method, an IPO method, or an option pricing method.

4. The method of claim 1, wherein the valuation is based on a discount for lack of control (DLOC) analysis.

5. The method of claim 1, wherein the valuation is performed without requiring comparable valuations obtained from third party valuation services.

6. The method of claim 1, wherein organizational historical parameters include organization profit, company net profit margin, company gross revenue, and three-year revenue.

7. The method of claim 1, wherein third party data includes sector net profit margin based on identification of a sector from a North American Industry Classification System (NAICS) code received from the organization via the web interface.

8. The method of claim 1, further comprising automatically generating one or more organizational change recommendations based on at least one lowest-scoring response to a question provided by the organization.

9. The method of claim 8, further comprising generating and displaying a value of a net change in valuation of the organization in response to successful adoption of the one or more organizational change recommendations.

10. An automated advising model hosting platform comprising:
a web interface configured to present a guided information collection interface to a client organization, the guided information collection interface presenting a series of screens requesting information regarding organizational goals, operating sector information, and responsive information regarding a plurality of organizational components corresponding to at least one of financial, operational, and leadership performance, the web interface being configured to receive response inputs at the web interface;
a third party data interface configured to obtain operating sector information from a third party sector database and obtain third party records providing historical third party financial data associated with the operating sector;
a scoring model configured according to features extracted based on the historical third party financial data, the scoring model being operable to generate a plurality of scores in response to the responsive information;
wherein the automated advising model hosting platform is configured to perform a valuation process to determine an overall score from the plurality of scores and generate one or more valuations of the organization based on the overall score and the organizational goals;
wherein the one or more valuations are generated based on the responsive information and the plurality of scores.

11. The automated advising model hosting platform of claim 10, further comprising:
a delta-based calculation engine configured to:
receive organizational performance data spanning multiple time periods from the client organization,
generate delta values by calculating percentage changes in organizational metrics over predetermined time periods rather than using absolute metric values, and
apply dynamic amplification factors to initial scores derived from the delta values, wherein scores meeting or exceeding a high performance threshold receive a positive amplification factor and scores at or below a low performance threshold receive a negative amplification factor;
wherein the scoring model is configured to weight the amplified scores using sector-specific weights determined from the historical third party financial data, enabling cross-organizational comparisons regardless of organizational size differences.

12. The automated advising model hosting platform of claim 11, wherein the platform is configured to:
generate different weighted score combinations based on the organizational goals, wherein a first weighting schema is applied when the organizational goals indicate operational objectives and a second weighting schema is applied when the organizational goals indicate sale preparation objectives;
maintain real-time API connections to external valuation databases that provide dynamically updated discount rates based on actual company transaction data; and
automatically update the sector-specific weights based on North American Industry Classification System (NAICS) codes received from the client organization and real-time external data integration with the external valuation databases.

13. A method of providing comparative business analysis using delta-based calculations, the method comprising:
presenting, at a web interface, a guided information collection interface requesting organizational performance data over a predetermined time period;
receiving response inputs representing organizational metrics from a client organization;
generating delta values by calculating percentage changes in the organizational metrics over the predetermined time period rather than using absolute metric values;
applying a dynamic scoring algorithm that:
assigns initial scores to the delta values based on predetermined range thresholds,
applies amplification factors to the initial scores based on score magnitude, wherein scores meeting or exceeding a high threshold receive a positive amplification factor and scores at or below a low threshold receive a negative amplification factor;
weighting the amplified scores using sector-specific weights determined from third-party comparative data associated with a business classification code;
generating different weighted score combinations based on organizational goals, wherein a first weighting schema is applied for operational goals and a second weighting schema is applied for sale-oriented goals; and
generating a comparative assessment based on the weighted score combinations, wherein the delta-based calculations enable cross-organizational comparisons regardless of organizational size differences.

14. The method of claim 13, wherein the amplification factors comprise:
a positive amplification factor of approximately 10% applied to scores of 4 on a 4-point scale; and
a negative amplification factor applied to scores of 1 on the 4-point scale.

15. The method of claim 13, wherein the delta values are calculated by:
obtaining current period metrics and historical period metrics from the client organization;
calculating percentage change between the current period metrics and historical period metrics; and
comparing the percentage change to sector-specific benchmarks obtained from external data sources.

16. The method of claim 15, wherein the sector-specific weights are dynamically updated based on:
North American Industry Classification System (NAICS) codes received from the client organization; and
real-time external data integration with third-party valuation databases providing sector-specific discount rates.

17. An automated business analysis system comprising:
a processor configured to execute instructions stored in memory; and
a delta-based calculation engine stored in the memory and executable by the processor to:
receive organizational performance data from a client interface,
generate comparative delta values from the organizational performance data,
apply dynamic amplification factors to initial scores derived from the delta values,
weight the amplified scores using sector-specific weightings obtained from external databases, and
generate multiple weighted assessments based on different organizational goal parameters.
